(19) United States
(12) Patent Application Publication
(10) Pub. No.: US 2024/0038992 A1
(43) Pub. Date: Feb. 1, 2024

(54) Anode Active Material, Containing Fullerene, for Metal Secondary Battery and Metal Secondary Battery Using Same

(71) Applicant: Pusan National University Industry-University Cooperation Foundation, Busan (KR)

(72) Inventors: Chae Ryong Cho, Busan (KR); Ling Hong Yin, Seoul (KR)

(21) Appl. No.: 18/268,771

(22) PCT Filed: Dec. 22, 2021
(86) PCT No.: PCT/KR2021/019568

§ 371 Date: Sep. 8, 2023

(30) Foreign Application Priority Data
Dec. 22, 2020 (KR) 10-2020-0181349

(51) Int. Cl. H01M 4/587; H01M 4/62; H01M 10/0525; C01B 32/156

(52) U.S. Cl. CPC H01M 4/587; H01M 4/625; H01M 4/622; H01M 10/0525; C01B 32/156; H01M 2004/027

(57) ABSTRACT

The present invention relates to an anode active material, containing fullerene, for a metal secondary battery and a metal secondary battery using the same. When the anode active material for a metal secondary battery of the present invention is nano-grained and used for an anode of a metal secondary battery, it has inherent electrochemical properties of C₆₀ fullerene so that excellent specific capacity was exhibited and enables high coulombic efficiency to be exhibited even after not less than 1,000 redox cycles so that it is suitable for use in the anode for a metal secondary battery.

### TECHNICAL FIELD

The present disclosure relates to an anode active material for a metal secondary battery containing fullerene and a metal secondary battery using the same.

### BACKGROUND ART

Since the mass synthesis method of C₆₀ was established in 1990, various studies on fullerenes have been developed. In addition, many fullerene derivatives have been synthesized, and the possibility of their practical use has been studied. One of the fields in which the possibility of practical use is expected is a battery. An example of such a battery may include a metal secondary battery.

However, since C₆₀ fullerene is insoluble or is not soluble at all in most solvents, there has been a problem in that it is difficult to handle it, and thus it has been difficult to use it. In addition, in most of conventionally published prior art documents, pure C₆₀ fullerene is not used, but fullerenes of other structures are mixed and used, or pure C₆₀ fullerene is chemically bonded or cross-linked with other materials and just applied, and although C₆₀ fullerene has been used in the field of batteries by utilizing its physical and chemical properties of pure C₆₀ fullerene, research has not continued since its specific capacity is much lower than the theoretical specific capacity (446 mAh/g).

For example, in the case of Korean Patent Publication No. 10-0793659, a cathode material for a metal secondary battery is disclosed by crosslinking fullerene with a cathode active material, but there is a problem in that the intrinsic properties of fullerene cannot be maintained as the active material and fullerene are crosslinked.

Accordingly, the present inventors completed the present disclosure by confirming that excellent electrochemical properties are obtained when pure C₆₀ fullerene is used as an anode active material for a metal secondary battery.

### DISCLOSURE

### Technical Problem

An object of the present disclosure is to provide a method for preparing an anode active material for a metal secondary battery, containing fullerene, an anode material for a metal secondary battery using the same, and a metal secondary battery using the same.

### Technical Solution

One aspect of the present disclosure for achieving the above object is a method for preparing an anode active material for a metal secondary battery, including the steps of:
1) pulverizing a fullerene compound;
2) heating the pulverized fullerene compound under a nitrogen or argon atmosphere; and
3) obtaining a fullerene deposit evaporated by heating.

The anode active material for a fullerene metal secondary battery, prepared through the above preparation method, is nano-grained, and has a uniform size so that it transports electrons and metal ions, for example, lithium ions more efficiently, and thus excellent specific capacity was shown when used in anode materials, and high coulombic efficiency could be exhibited even after not less than 1,000 charge/discharge cycles.

In the step 1), pulverization is a step of powdering the fullerene compound, and allows evaporation to be smoothly performed during the reaction into the heating step. These pulverization conditions are preferably dry pulverization, and may be selected from the group consisting of ball milling, attrition milling, high energy milling, jet milling, and mortar and pestle grinding. Through such pulverization, it may be possible to provide a compound in the form of a powder that maintains the structure of pure fullerene.

The fullerene compound is preferably pure C₆₀ fullerene, and it is not preferable to use C₇₀ fullerene and other fullerene compounds and composites having an initial irreversible capacity of 300% or more and low cycle stability.

In the step 2), it is preferable to heat samples to a temperature of 700 to 900° C. in a nitrogen or argon atmosphere, and it is more preferably to heat it to a temperature of 800° C., but is not necessarily limited thereto. When the heating is performed at less than 700° C., the evaporation of fullerene is not smooth, and when the heating is performed at more than 900° C., fullerene is thermally decomposed, and thus a large weight loss may occur, or it may be changed to other materials.

The heating is preferably performed for 90 to 150 minutes, and more preferably performing the heating for 120 minutes is the easiest in securing the physical properties of the nanoparticles. However, these conditions may change depending on the amount of samples to be supplied, and there may be no time limit in the case of continuously supplying the samples.

C₆₀ fullerene nanoparticles may be obtained through deposition after such heating, and the nanoparticles thus obtained have a uniform particle diameter so that transportation of electrons and metal ions, for example, lithium ions may be performed very quickly.

In the step 3), the step of obtaining the deposit after performing deposition on a peripheral portion of the furnace with a relatively low temperature compared to the central portion of the heat treatment tube furnace is preferably carried out at room temperature by mounting a cold trap and the like, but it is not necessarily limited thereto. The room temperature is preferably a temperature of 20° C. to 30° C.

Another aspect of the present disclosure for achieving the above object is to provide an anode active material for a metal secondary battery, which is prepared using the above preparation method.

The anode active material for a metal secondary battery may be included together with an anode electrically conductive material and a binder to form an anode material for a metal secondary battery.

The anode electrically conductive material is preferably carbon black, but is not necessarily limited thereto, and the binder is preferably methyl cellulose, styrene butadiene rubber, or a combination thereof, but is not necessarily limited thereto.

The anode electrically conductive material is mixed with a binder and used as an anode material for a metal secondary battery, but the anode active material for a metal secondary battery is characterized in that it is physically mixed with or adhered to the binder and the anode electrically conductive material so that it is only used as an anode material, but is not chemically bonded therewith. Therefore, the anode active material for a metal secondary battery may have excellent electrochemical properties by preserving the inherent characteristics of fullerene nanoparticles.

Furthermore, the present disclosure provides an anode for a metal secondary battery, including the anode material for a metal secondary battery.

Furthermore, the present disclosure provides a metal secondary battery including the anode for a metal secondary battery.

The metal secondary battery may be preferably any one selected from the group consisting of a lithium secondary battery, a potassium secondary battery, and a sodium secondary battery. Most preferably, the metal secondary battery is a lithium secondary battery.

The present disclosure provides a metal secondary battery including the anode for a metal secondary battery in which an electrolyte is liquid or solid. When the electrolyte is liquid, this is called a metal ion secondary battery. When the electrolyte is solid, this is called an all-solid-state secondary battery.

Redundant content is omitted in consideration of the complexity of the present specification, and terms not otherwise defined in the present specification have meanings commonly used in the technical field to which the present disclosure belongs.

### Advantageous Effects

When the anode active material for a metal secondary battery according to the present disclosure is nano-grained and used for an anode of a metal secondary battery, it has inherent electrochemical properties of C₆₀ fullerene so that excellent specific capacity was exhibited, and enables high coulombic efficiency to be exhibited even after not less than 1,000 redox cycles so that it is suitable for use in the anode for a metal secondary battery.

### DESCRIPTION OF DRAWINGS

FIG. 1 shows schematic views, SEM images, a TEM image, XRD patterns, and Raman spectrum results of fullerene nanoparticles.

FIG. 2 is schematic views of the fullerene nanoparticle preparation process and evaluates the effects of the temperature gradients of the tube used in the preparation process.

FIG. 3 evaluates the degree of weight loss according to thermogravimetric analysis of HGC₆₀ and fullerene nanoparticles.

FIG. 4 shows an SEM image, an optical image, XRD patterns, and Raman spectrum results of fullerene nanoparticles.

FIG. 5 shows XPS results and SIMS depth composition distribution results of fullerene nanoparticles.

FIG. 6 shows the electrochemical properties of fullerene nanoparticles.

FIG. 7 shows the results of GITT analysis of fullerene nanoparticles.

### MODES OF THE INVENTION

### Example 1. Preparation of Fullerene Nanopowder

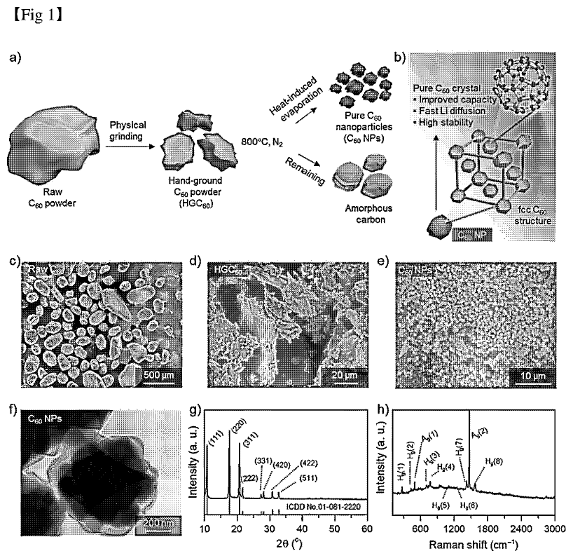

FIG. 1A is a schematic view for the synthesis of fullerene nanoparticles (C₆₀ NPs or C₆₀ nanoparticles) of the present disclosure, FIG. 1B is a schematic diagram showing the structure of the fullerene nanoparticles of the present disclosure, and the specific synthesis method of the fullerene nanoparticles is as follows.

A fullerene mixture was obtained from the carbon product obtained using arc discharge, and then this was extracted using a Soxhlet extractor. Purification of low molecular weight fullerenes (Cₙ<60) and high molecular weight fullerenes (Cₙ>70) was performed using high performance liquid chromatography (HPLC).

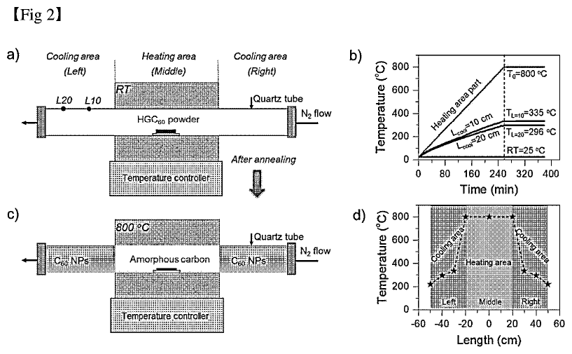

Pure C₆₀ fullerenes were collected using Buckyprep column HPLC with toluene as the mobile phase, where only pure C₆₀ powder was collected. The pure C₆₀ particles obtained were a bright black powder (0.15 g) (named raw C₆₀ powder, FIG. 1C), and a relatively fine brown C₆₀ powder (as a hand-milled C₆₀ powder, this was named HGC₆₀ powder, FIG. 1D) that was free from an agglomerated state by hand grinding it for up to 5 minutes was collected, and then transferred into a fused quartz tube electric furnace (FIG. 2A). Air was removed from the tube by filling it with N₂ gas three times in vacuum, and then directly heated at a temperature of 800° C. for 2 hours in a nitrogen (99.999%) atmosphere (heating rate: 3° C. per minute, FIG. 2C). After the heating process was finished and the C₆₀ powder was cooled to room temperature, the deposited resulting product was carefully collected, and this was named as C₆₀ NPs (FIG. 1E), and the crystal phase was confirmed by XRD and Raman analysis (FIGS. 1G to 1H).

In the process of heating up to 800° C. with N₂ gas, structural collapse occurred due to the high temperatures, most of the C₆₀ molecules sublimated and recrystallized from the bulk powder and deposited on the inner wall of the tube end, and this was due to a large temperature difference between the electric furnace and the portion of the tube exposed to the air (FIGS. 2A and 2B). The distribution of the highest temperature with respect to the tube length after reaching 800° C. is shown in FIG. 2D.

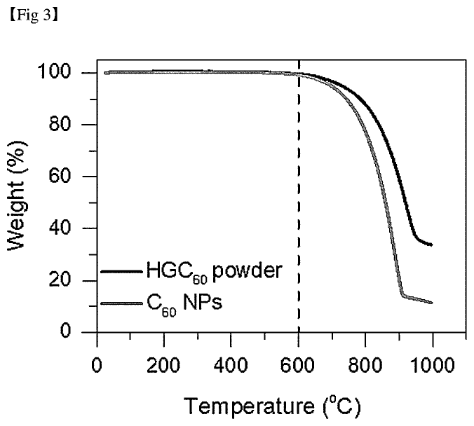

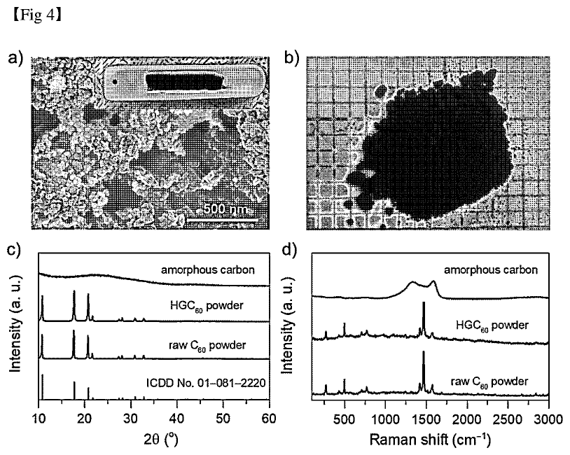

The TGA results for weight loss of HGC₆₀ and C₆₀ NPs in an N₂ atmosphere are shown in FIG. 3. After cooling them to room temperature, it was confirmed that some black by-products remained without evaporation since the C₆₀ molecules lost the ring and the FCC crystal structure and formed a porous carbon material (FIG. 4A). The amorphous phases of the by-products were further confirmed by XRD and Raman analysis (FIGS. 4C and 4D).

Regarding the formation mechanism, the fused quartz tube is an insulating material, and thus no free electrons can move along the tube. However, the relatively weak π-π interaction between the C₆₀ molecules and the tubes induced the first thin film growth and the second layer, and then allowed C₆₀ islands to be appeared and resulted in high molecular diffusivity. Therefore, C₆₀ NPs with uniform morphology were formed layer by layer and could be easily collected from the surface of the fused quartz tube. The photographs of C₆₀ NPs collected in the fused quartz tube in FIG. 2C showed a powder state as shown in FIGS. 1E and 4B.

### Example 2. Analysis of Physicochemical Properties of Fullerene Nanopowder

(1) Analysis Method

The crystal structure of the C₆₀ nanopowder prepared in Example 1 was irradiated by X-ray diffraction (XRD, XPERT-3, PANalytical) in the θ-2θ scan mode in the 2θ range of 10˜60° using Cu Kα1 X-rays. In situ XRD measurements were performed to observe the structural changes of the C₆₀ NPs anode active material in the 2θ range of 10˜40° during the charge/discharge process, and an in situ electrochemical analyzer and cell were used for this. A copper thin film (about 200 nm) sputtered onto a beryllium metal substrate (about 25 um thick) at 130° C. was prepared, and the slurry was applied thereon with a doctor blade and then dried. A Raman spectrometer (Raman, HORIBA Jobin Yvon, LabRam HR) using a 514 nm laser as an excitation source was used to obtain information on molecular vibrations and crystal structure. The surface morphologies of the C₆₀ samples were characterized using a field emission scanning electron microscope (FESEM, S-4700, Hitachi). During the first discharge, lithiated anode samples prepared at different voltages were manufactured with a dual beam focused ion beam (FIB, Helios NanoLab 450, FEI) system. The thickness of the samples etched by the gallium ion beam was approximately less than 100 nm. The crystal structure of the samples and the elements carbon and lithium were analyzed using a transmission electron microscope (TEM, Titan3 G2 60-300 microscope, FEI) on which a dual Cs-aberration corrector and monochromator, and an UltraScan 1000 CCD and a Gatan Quantum 965 dual electron energy loss spectrometer (EELS) system were mounted. System conditions for TEM analysis such as accelerating voltage, exposure time and resolution were 80 kV, 0.2 s, and 2048×2048 pixels, respectively. High angle angular dark field (HAADF)-STEM imaging acquisition conditions included an acceleration voltage of 80 kV and a convergence angle of 26 mrad. The HAADF detector had an internal collection angle of 52 mrad and an external collection angle of 340 mrad. All images shown were 1024×1024 pixels across a 16 μs dwell time. Selected area electron diffraction (SAED) patterns were acquired with Fast Fourier.

The corresponding domain axis and plane index were determined by performing analysis using HRTEM images' transformation (FFT) and CrysTBox software and quantifying the distance and angle between the diffraction spots. EELS was performed at an accelerating voltage of 80 kV. The energy spread of ZLP was 0.8 eV, the energy dispersion was 0.1 eV channel, and the exposure time ranged from 0.004 s (low loss) to 1 s (high loss).

The chemical bonding state of C60 NPs was analyzed by X-ray photoelectron spectroscopy (XPS, K-Alpha+, Thermo Fisher Scientific) using a multi-channel detector in the range of 0 to 1200 eV with monochromatic Al—Kα radiation (1486.6 eV). The spectral binding energy was calibrated using the C1s peak (284.6 eV).

TOF-SIMS experiments on C₆₀ NPs films on Pt/Si substrates were performed with a TOF-SIMS 5 (IONTOF GmbH, Münster) using a pulsed 30 keV Bi³⁺ primary beam with a current of 0.60 pA. The analysis area used in this work was a square of 200 μm×200 μm. Anion spectra were internally normalized to their respective secondary total ion yields using the H⁻, C⁻, C²⁻, C³⁻, and C⁴⁻ peaks. Chemical images of the analyzed area were recorded at 128×128 pixel resolution during data collection. The depth profile was a square of 500 μm×500 μm using an Ar⁺ ion cluster of 20 keV and 13 nA.

Thermogravimetric analysis (TGA, STA 6000 thermal analyzer, PerkinElmer) of the samples was performed at 25 to 1,000° C. (heating rate of 10° C. min⁻¹) in an N₂ atmosphere.

(2) Property Analysis Results

The SEM image of C₆₀ NPs is shown in FIG. 1E, the morphology of C₆₀ NPs is clearly different from that of the HGC₆₀ powder, and the grain size of C₆₀ NPs is greatly reduced so that they were more uniform and smooth by about hundreds of nanometers. C₆₀ NPs were composed of small particle clusters as shown in the TEM image of FIG. 1F. The microstructure of the C₆₀ sample was further analyzed using X-ray diffractometer (XRD) measurements. A typical XRD pattern is shown in FIG. 1G, and the diffraction peaks of (111), (220), (311), (222), (331), (420), (422), and (511) show a typical crystal structure of Fm-3m fullerene which is cubic. The results confirmed that C₆₀ NPs perfectly maintained the original structure of the fullerene derived from the C₆₀ powder. No impurity peak was detected, and thus it was suggested that FCC phase-pure C₆₀ NPs could be obtained through evaporation and recrystallization process and that C₆₀ NPs could be collected in large quantities.

The crystal qualities of raw C₆₀ and HGC₆₀ were similar to that of C₆₀ NPs, as shown in FIG. 4C. The Raman spectrum showed typical characteristic peaks of C₆₀ NPs mainly including 8 Hg bands and 2 Ag bands as shown in FIG. 1H. Eight Hg bands were present at 271, 431, 707, 773, 1100, 1249, 1424, and 1573 cm⁻¹, respectively. Another two Ag modes were located at 496 and 1468 cm⁻¹ corresponding to the breathing mode and the pentagonal pitch mode, respectively. The results indicated that C₆₀ NPs derived from the HGC₆₀ powder could well retain the FCC structure of the solid raw material C₆₀ (FIG. 4D). This was a clear difference compared to previously published C₆₀ related anodes in lithium ion batteries, and most of the previously published C₆₀ related anodes have been changed to polymerized C₆₀ or amorphous carbon.

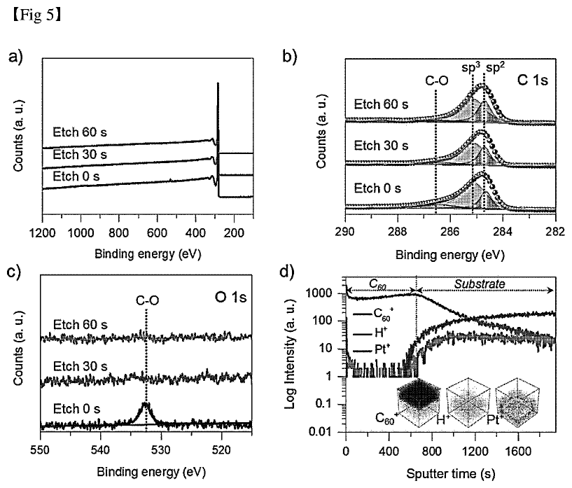

The surface chemical bonding state and chemical composition of the C₆₀ nanoparticles were analyzed using X-ray photoelectron spectroscopy (XPS), and are shown in FIGS. 5A to 5C. Referring to FIG. 5A, it can be confirmed that element C exists as the main peak and element oxygen exists as the only impurity peak with very weak intensity. FIG. 5B shows the high-resolution C is spectrum, and the peaks at 284.7 and 285.1 eV were assigned sp² (C═C bond) and sp³ (CC bond), respectively. The small peak located at 286.4 eV is due to physically adsorbed carbon oxides. To confirm this, the surface of C₆₀ NPs was etched using Ar⁺ ions, and weak peaks could be removed after 30 seconds of etching. Therefore, it could be confirmed that the impurity peak detected at up to 532 eV (O1s, FIG. 5C) was oxygen due to the contribution of physically adsorbed C—O molecules located on the C₆₀ surface. Even after 60 seconds of etching, it could be confirmed that the main C1s peak was still present and the O1s peak could be no longer detected.

The purity of pure C₆₀ NPs was confirmed by time-of-flight secondary ion mass spectrometry (TOF-SIMS), and the results are shown in FIG. 5D. C₆₀ NPs were deposited for further use by putting Pt (100 nm)/Si into the cold part of a fused quartz tube as a substrate. Within about 700 seconds of sputter time, H⁺ and Pt⁺ were not completely present, and C₆₀⁺ was uniformly distributed on the substrate surface. An image inserted in FIG. 5D shows a three-dimensional mapping image of positive charges of H⁺, Pt⁺, and C₆⁺. Referring to FIG. 5D, it can be confirmed that C₆₀Hₓ is not present, and it can be confirmed that it is pure C₆₀. As the sputter time increased to about 700 seconds or more, it could be confirmed that the intensity of C₆₀⁺ gradually decreased and those of H⁺ and Pt⁺ gradually increased.

### Example 3. Analysis of Electrochemical Properties of Fullerene Nanopowder

(1) Analysis Method

The electrochemical performance of the C₆₀ active material was analyzed in a C₆₀/Li half-cell. An anode electrode was prepared by mixing carbon black, an electrically conductive material, with carboxymethylcellulose/styrene butadiene rubber as a binder (CMC/SBR=1:1 wt %, using deionized water as a solvent). The weight ratio was 70:15:15 (In order to prepare raw C₆₀ anode, carbon black and binder were mixed, dispersed, and then raw C₆₀ powder was added thereto. In the case of HGC₆₀ powder and C₆₀ NPs, they were finely pulverized in a mortar and pestle). The slurry was spread on a copper foil with a doctor blade, dried in vacuum at 60° C. for 10 hours, and then punched into disks, each 1.4 cm in diameter. The electrolyte was a 1M LiPF₆ solution of ethylene carbonate (EC)/diethyl carbonate (DEC) (1:1 vol %), containing 10% fluoroethylene carbonate. Lithium metal was used as the counter and reference electrodes. CR2032 coin cells were assembled into an argon-filled glove box. Electrochemical tests of the samples were investigated using a multi-channel potentiostat/galvanostat battery test station (Wonatech, WMPG1000) in the voltage range of 0.01 to 3.0 V (vs Li/Li⁺). Cyclic voltammetry (CV) tests were performed at scan rates of 0.1 to 5 mV s⁻¹. Galvanostatic Intermittent Titration Technique (GITT) was performed on a multi-channel electrochemical workstation (ZIVE MP1) after 4 hours of relaxation at 30 min intervals under a current density of 100 mA g⁻¹. Electrochemical impedance spectroscopy (EIS) analysis and temperature-dependent cycling performance were also performed using the ZIVE MP1 in the frequency range of 100 kHz to 0.01 Hz. For the whole cell test, the cell was assembled using a C₆₀ NPs anode and an LiFePO₄ cathode. The C₆₀ NP anode was first pre-lithiated in a half-cell for 3 cycles at a current density of 170 mA g⁻¹, charged (delithiated) to 3.0 V, and then, as the anode of a full cell, paired with the LiFePO₄ cathode. The specific capacity of the entire battery was evaluated based on the mass of the anode active material.

(2) Electrochemical Property Analysis

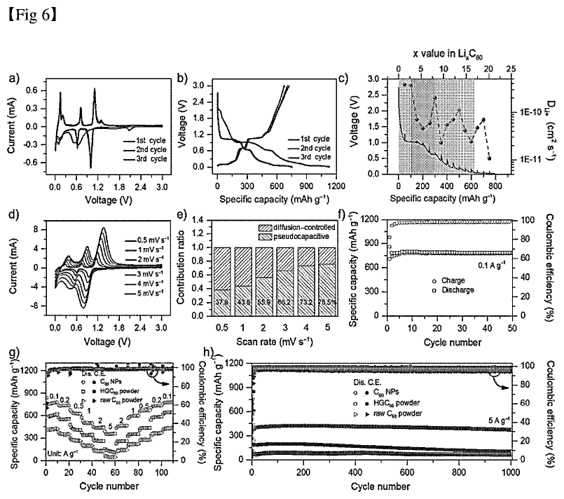

FIG. 6 showed the electrochemical performance of the C₆₀ sample. FIG. 6A showed the CV curves of the C₆₀ NPs anode during the initial 3 cycles at a scan rate of 0.1 mV s⁻¹. Compared to raw C₆₀ and HGC₆₀ samples, the reversible cathodic/anodic peaks of C₆₀ NPs were much sharper and clearer in the second and third cycles. Oxidation peaks at 0.15, 0.19, 0.23, 0.72, 1.11, and 1.28 V overlapped during the cycle corresponding to delithiation on LiₓC₆₀. In the first anodic process, a small reduction peak of 2.09 V was assigned to the reductive decomposition of a carbonate solvent. The broad anodic peak located at 0.26 V was mainly due to the formation of a solid electrolyte interphase (SEI) film on the electrode surface, and it was disappeared during proceeding of subsequent cycles. Another small anodic peak corresponding to one in which Li⁺ ions were inserted into the C₆₀ lattice appeared at about 0.05 V. FIG. 6B shows the rectifying charge-discharge curves of the initial three cycles at 0.1 A g⁻¹. The voltage flat section was well coincided with the peak positions of the CV curves to show high consistency. The discharge/charge specific capacity during the first cycle was 1130/674 mAh g⁻¹ with a coulombic efficiency of 59.6%. The large irreversible capacity may be since the Li⁺ ions are irreversibly intercalated due to the formation of the SEI layer and the reductive decomposition of the carbonate solvent. For the second and third cycles, the discharge/charge specific capacities and coulombic efficiencies were 754/706 and 752/722 mAh g⁻¹ and 93.6 and 96.0%, respectively. FIG. 6C provides Galvanostatic Intermittent Titration Technique (GITT) data related to Li⁺ ion diffusion coefficient (D_{Li+}) values during the second discharge.

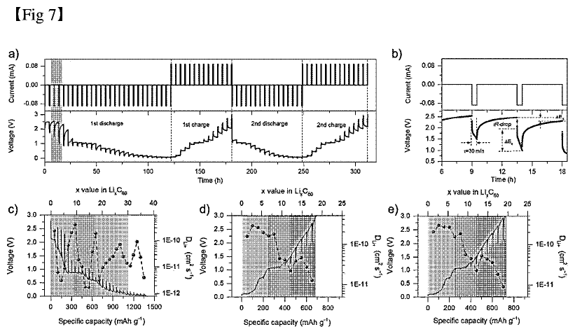

FIGS. 7A and 7B show schematic diagrams for GITT measurement of voltage changes with respect to input current pulses during 2 cycles. The DLi⁺ values increased due to the chemical reaction between the active material and Li⁺ ions compared to other regions. In the second discharge process, the DLi⁺ values were 3.94×10⁻¹⁰ cm²s⁻¹ (maximum value) for Li_{9.4}C₆₀ and 1.08×10⁻¹¹ cm²s⁻¹ (minimum value) for Li_{20.1}C₆₀, respectively. The GITT data during the first charge/discharge and second charge processes were shown in FIGS. 7C to 7Ee, and the DLi⁺ values showed almost similar behaviors except for the high specific capacities of the first discharge. The CV curves at different scan rates of 0.5-5 mV s⁻¹ were shown in FIG. 6D, and it could be confirmed that the cathodic/anodic peaks representing Li⁺ intercalation/deintercalation behaviors shifted to lower and higher potentials, respectively. As the scan rate increased, all redox peaks were still well maintained with a small potential difference at a high scan rate of 5 mV s⁻¹. The diffusion-controlled and pseudocapacitive contributions of the C₆₀ NPs anode at various current densities from 0.1 to 5 A g⁻¹ were shown in FIG. 6E. Although the specific capacity decreases gradually with increasing current density, the lithiation/delithiation stability cycles were still clearly identified and were almost the same even at a high current density of 5 A g⁻¹. A cycling test was performed to evaluate the cycling stability. In the case of C₆₀ NP, it exhibited a low current density of 0.1 A g⁻¹ and discharge specific capacity of 786 mAh g⁻¹ after 50 cycles due to excellent stability and low retention rate (FIG. 6F). FIG. 6G showed the rate performance of three C₆₀ anodes as predicted by other analyses. The C₆₀ NPs electrode exhibited relatively high reversible discharge specific capacities of 778, 734, 620, 499, 440, and 359 mAh g⁻¹ at current densities of 0.1, 0.2, 0.5, 1.0, 2.0, and 5.0 A g⁻¹. As the current density returned to 2.0, 1.0, 0.5, 0.2, and 0.1 A g⁻¹, reversible specific capacities of 464, 595, 666, 731, and 782 mAh g⁻¹, respectively, could be obtained. For comparison, the HGC₆₀ powder exhibited reversible discharge specific capacities of 615, 550, 408, 343, 257, and 107 mAh g⁻¹ at current densities of 0.1, 0.2, 0.5, 1.0, 2.0, and 5.0 A g⁻¹, respectively. Reversible specific capacities of 258, 350, 434, 581, and 643 mAh g⁻¹ could be obtained, respectively, with current densities gradually returning to low current densities of 2, 1, 0.5, 0.2, and 0.1 A g⁻¹. The values of raw C₆₀ powder showed only 422, 351, 260, 198, 126, and 43 mAh g⁻¹ for reversible discharge capacities at current densities of 0.1, 0.2, 0.5, 1.0, 2.0, and 5.0 A g⁻¹. The current densities recovered to 2, 1, 0.5, 0.2, and 0.1 A g⁻¹, but the values of raw C₆₀ powder remained at 141, 219, 274, 368, and 437 mAh g⁻¹, respectively. For long cycling performance at high current densities, the anode was evaluated at 5 A g⁻¹ (after 5 cycles at 0.1 A g⁻¹). As shown in FIG. 6H, C₆₀ NP maintained a reversible capacity of 408 mAh g⁻¹ after 500 cycles. HGC₆₀ powder and raw C₆₀ powder showed 154 and 81 mAh g⁻¹, respectively. Up to 1000 cycles, it was confirmed that C₆₀ NP still maintained 373 mAh g⁻¹ and the HGC₆₀ powder and raw C₆₀ powder remained at only 105 and 64 mAh g⁻¹ with coulombic efficiencies of 98.7, 98.6, and 94.4%, respectively. It could be seen that the significant improvement of C₆₀ NPs as an anode material (e.g., excellent cycling stability and rate capability) is related to the shorter path (transportation of both electrons and Li⁺ ions) due to the uniform particle size compared to other C₆₀ powders.

1. A method for preparing an anode active material for a metal secondary battery, comprising:
1) pulverizing a fullerene compound;
2) heating the pulverized fullerene compound under a nitrogen or argon atmosphere; and
3) obtaining a fullerene deposit evaporated by heating.

2. The method of claim 1, wherein the fullerene compound is C₆₀.

3. The method of claim 1, wherein the heating is performed at a temperature of 700 to 900° C.

4. The method of claim 1, wherein the heating is performed for 90 to 150 minutes.

5. The method of claim 1, wherein the metal is any one selected from the group consisting of lithium, sodium, and potassium.

6. An anode active material for a metal secondary battery, which is prepared using the preparation method of claim 1.

7. An anode material for a metal secondary battery, comprising the anode active material for a metal secondary battery according to claim 6, an anode electrically conductive material, and a binder.

8. The anode material for a metal secondary battery of claim 7, wherein the anode electrically conductive material is carbon black.

9. The anode material for a metal secondary battery of claim 7, wherein the binder is methyl cellulose, styrene butadiene rubber, or a combination thereof.

10. The anode material for a metal secondary battery of claim 7, wherein the anode active material for a metal secondary battery is not chemically bonded with the anode electrically conductive material and the binder.

11-12. (canceled)

13. The anode material for a metal secondary battery of claim 7, wherein the metal secondary battery comprises an electrolyte which is liquid or solid.
